(19) United States
(12) Patent Application Publication
(10) Pub. No.: US 2024/0149721 A1
(43) Pub. Date: May 9, 2024

(54) CHARGING/DISCHARGING STATION

(71) Applicant: GS Yuasa International Ltd., Kyoto-shi, Kyoto (JP)

(72) Inventors: Masakatsu KURISAKA, Kyoto (JP); Yuta MIZUKAWA, Kyoto (JP); Toshiyuki TAKEHARA, Kyoto (JP)

(21) Appl. No.: 18/278,342

(22) PCT Filed: Jan. 27, 2022
(86) PCT No.: PCT/JP2022/003124

§ 371 Date: Aug. 22, 2023

(30) Foreign Application Priority Data
Feb. 24, 2021 (JP) 2021-027368
Feb. 24, 2021 (JP) 2021-027369
Jan. 12, 2022 (JP) 2022-002956

(51) Int. Cl. B60L 53/31; B60L 53/30; B60L 53/63; B60L 53/67

(52) U.S. Cl. CPC B60L 53/31; B60L 53/305; B60L 53/63; B60L 53/67; B60L 2240/80

(57) ABSTRACT

A vehicle charge-discharge station 50A includes a plurality of charge-discharging devices 51 and a display device 95 that collectively displays modes regarding charge-discharge of the plurality of charge-discharge devices 51.

### TECHNICAL FIELD

The present invention relates to a technique for improving convenience of a charge-discharge station.

### BACKGROUND ART

In recent years, electrification of a vehicle has progressed from the viewpoint of tightening environmental regulations and reducing CO2 emissions, and preparation for a charge infrastructure is urgently needed for full-spread use of an electric vehicle (EV) and a plug-in hybrid electric vehicle (PHEV). On the other hand, there is a demand for a system capable of supplying electric power to a load when a power failure is generated during a disaster. In order to meet these requirements, a bidirectional charge-discharge device (charge-discharge stand) having a discharging function in addition to a charging function of the vehicle has been proposed (Patent Document 1).

### PRIOR ART DOCUMENT

### Patent Document

Patent Document 1: JP-A-2020-10442

### SUMMARY OF THE INVENTION

### Problems to be Solved by the Invention

Any one of a plurality of modes regarding charge-discharge such as “a charging mode” and “a discharging mode” may be selected and set for the charge-discharge device. A manager (for example, a manager of a public facility having a charge-discharge station on a site) of a charge-discharge station in which a plurality of charge-discharge devices are installed can set a mode for each charge-discharge device depending on a time and a case. In this occasion, it is desirable that a user of the charge-discharge station can easily check the mode of each charge-discharge device. When the mode can be easily checked, for example, the user who visits the station to charge the vehicle can avoid connecting the vehicle to the charge-discharge device set to the discharging mode by mistake.

A method in which the mode of each charge-discharge device is displayed on a display panel of each charge-discharge device to urge the user or the manager of the station to check the mode for each charge-discharge device is conceivable. However, in this method, particularly when the plurality of charge-discharge devices are provided in the station, it takes time and labor for the user to search for the charge-discharge device suitable for own needs.

The present invention provides a technique improving to the convenience of the charge-discharge station.

### Means for Solving the Problems

A vehicle charge-discharge station according to a first aspect of the present invention includes a plurality of charge-discharge devices and a display device that collectively displays modes regarding charge-discharge of the plurality of charge-discharge devices.

A charge-discharge station according to a second aspect of the present invention includes a plurality of charge-discharge devices and a display device that collectively displays a use condition and a use schedule of the plurality of charge-discharge devices.

### Advantages of the Invention

According to the first aspect, as compared with a case where the mode regarding charge-discharge is individually displayed for each charge-discharge device, the time and labor required for the user or the manager to check the mode can be reduced to improve the convenience of the charge-discharge station.

According to the second aspect, the use condition and the use schedule of each charge-discharge device are collectively displayed, so that the convenience of the charge-discharge station can be improved and efficient operation of the charge-discharge station can be promoted.

### BRIEF DESCRIPTION OF THE DRAWINGS

FIG. 1 is a system configuration diagram illustrating a charge-discharge station.

FIG. 2 is a perspective view illustrating the charge-discharge station.

FIG. 3 is a perspective view illustrating the charge-discharge station.

FIG. 4 is a perspective view illustrating a charge-discharge stand.

FIG. 5 is a block diagram illustrating the charge-discharge stand.

FIG. 6 illustrates a display example of a mode.

FIG. 7 is a system configuration diagram illustrating a charge-discharge station.

FIG. 8 illustrates a display example of a mode.

FIG. 9 illustrates a display example of a mode.

FIG. 10 is a system configuration diagram illustrating a charge-discharge station.

FIG. 11 is a block diagram illustrating an information terminal device.

FIG. 12 illustrates a display example of a mode.

FIG. 13 is a perspective view illustrating a charge-discharge station.

FIG. 14 is a front view illustrating a multi-connection type charge-discharge stand.

FIG. 15 is a view illustrating an example of a display mode in a display panel.

FIG. 16 is a view illustrating an example of the display mode in the display panel.

FIG. 17 is a view illustrating an example of the display mode in the display panel.

FIG. 18 is a perspective view illustrating a charge-discharge station.

FIG. 19 is a view illustrating an example of the display mode in the display panel.

FIG. 20 is a view illustrating an example of the display mode in the display panel.

### MODE FOR CARRYING OUT THE INVENTION

An outline of a charge-discharge station according to the first aspect will be described.

A vehicle charge-discharge station includes a plurality of charge-discharge devices and a display device that collectively displays modes regarding charge-discharge of the plurality of charge-discharge devices.

Here, the “display device” may be provided separately from the plurality of charge-discharge devices in the charge-discharge station, or may be provided integrally with any one of the plurality of charge-discharge devices. The “display device” may be provided at a place away from the charge-discharge device (that is, a parking space).

In this configuration, the modes regarding the charge-discharge of the plurality of charge-discharge devices are collectively displayed on the display device, so that time and labor required for a user or a manager to check the mode can be reduced to improve convenience of the charge-discharge station as compared with a case where the modes are individually displayed for each charge-discharge device.

For example, the user who visits the station to charge a vehicle can quickly find the charge-discharge device to which the user's own vehicle should be connected by checking the display device.

The display device may display the plurality of charge-discharge devices by grouping the charge-discharge devices according to the mode, and display the mode for each group.

In this configuration, the mode can be easily checked as compared with the case where the mode is displayed for each charge-discharge device on the display device. In particular, it is effective when the number of charge-discharge devices provided in the station is large.

When the mode is to be switched, the display device may display transition information about the mode.

Efficient use of the charge-discharge station can be promoted by displaying the transition information and notifying the user of the mode switching.

The display device may collectively display the modes regarding the charge-discharge of the charge-discharge devices respectively installed in parking spaces located in a dispersed manner.

When the display device collectively displays the modes regarding the charge-discharge of the charge-discharge devices located apart from each other, the user or the manager is not required to move between the charge-discharge devices for the mode check. Therefore, the labor required for checking the mode can be greatly reduced.

The vehicle charge-discharge station includes the plurality of charge-discharge devices and the control unit, and the control unit transmits display information for collectively displaying the mode regarding the charge-discharge of the plurality of charge-discharge devices to an information terminal device connected through a network in response to a request from the information terminal device.

In this configuration, even when the user or the manager is not in the charge-discharge station, the information terminal device can check the mode regarding the charge-discharge of each charge-discharge device, and efficient use of the charge-discharge station can be promoted.

An outline of the charge-discharge station according to the second aspect will be described below.

The charge-discharge station includes the plurality of charge-discharge devices and the display device that collectively displays a use condition and a use schedule of the plurality of charge-discharge devices.

“Display the use condition” means to display information by which it can be determined whether the charge-discharge device is currently used. “Display the use schedule” means to display information about a current or future use schedule of the charge-discharge device.

In this configuration, when the use condition of each charge-discharge device is collectively displayed on the display device, the user can easily determine which charge-discharge device is being used and which charge-discharge device is available, and the convenience is high. In this configuration, when the use schedule of each charge-discharge device is displayed on the display device, the user or the manager can be urged to operate the charge-discharge station in a planned manner.

The display device may display a scheduled use end time of each charge-discharge device or a remaining time until the use end as the use schedule.

With this configuration, the next user who wants to use the charge-discharge device can attempt to use the charge-discharge device according to the scheduled use end time of the charge-discharge device. Consequently, efficient operation of the charge-discharge station can be promoted.

The display device may collectively display the use condition and the use schedule of the plurality of charge-discharge devices installed in each of the plurality of parking spaces located in a distributed manner.

The display device collectively displays the use condition and the use schedule of each charge-discharge device located apart from each other, so that the user or the manager is not required to move between the charge-discharge devices for the mode check. Consequently, the time and labor required for checking the use condition and the use schedule can be greatly reduced.

The charge-discharge station includes the plurality of charge-discharge devices and the control unit, and the control unit transmits display information for collectively displaying the use condition and the use schedule of the plurality of charge-discharge devices to the information terminal device connected through the network in response to the request from the information terminal device.

In this configuration, even when the user or the manager is not in the charge-discharge station, the use condition and the use schedule of each charge-discharge device can be checked by the information terminal device, and efficient use of the charge-discharge station can be promoted.

The display device may display presence or absence of a next use reservation of each charge-discharge device as the use schedule.

In this configuration, the user who looks at the display device can know the presence or absence of the next use reservation of the charge-discharge device, so that the user can use the charge-discharge station more systematically.

The display device may display a service mode of each charge-discharge device. “Displaying the service mode” means to display information about the mode of the service that can be provided to the user, such as the charge-discharge device capable of rapidly charging or the charge-discharge device capable of performing the connection for an energy management purpose.

By displaying the service mode, the user can be notified which charge-discharge device should be used. This can promote the efficient use of the charge-discharge station.

At least one charge-discharge device among the plurality of charge-discharge devices may be a multi-connection type charge-discharge device to which a plurality of vehicles can be connected.

With this configuration, the number of charge-discharge devices to be installed can be reduced without changing the number of vehicles connectable to the charging station, and cost required for installation, maintenance, and management can be reduced.

The display device may display a charge status or a discharge status of each vehicle connected to the multi-connection type charge-discharge device as the use condition. When the charge status such as the charge standby state, the charge state, and the charge end state is displayed, the user can be notified of the use condition of the charge-discharge device. The same applies to the case of discharge.

The display device may display a charge output from the multi-connection type charge-discharge device to each vehicle or a discharge output from each vehicle to the multi-connection type charge-discharge device as the use condition. When the charge output from the charge-discharge device to the vehicle or the discharge output from the automobile to the charge-discharge device is displayed, the user can be notified how much output the vehicle is charged or how much output the vehicle is discharged from the automobile to the charge-discharge device.

The display device may display priority order of which vehicle is preferentially charged or which vehicle is preferentially discharged for a plurality of vehicles connected to the multi-connection type charge-discharge device as the use schedule.

When the priority order of the charge or the discharge is displayed, the user can be notified of the order in which charge of the vehicle is started.

Hereinafter, embodiments of the present invention will be described with reference to the drawings, but the present invention is not limited to the embodiments.

### First Embodiment

### 1. Detailed Description of Charge-Discharge Station 50A

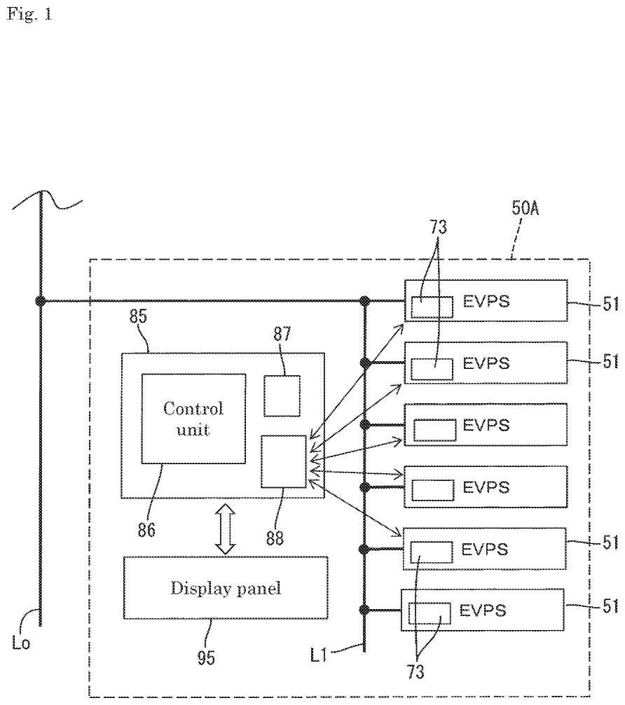

FIG. 1 is a system configuration diagram illustrating a charge-discharge station 50A. The charge-discharge station 50A includes a plurality of charge-discharge stands 51 (EV power supplies), a management device 85, and a display panel 95. The charge-discharge stand 51 is an example of a “charge-discharge device”, and the display panel 95 is an example of a “display device.

Each charge-discharge stand 51 is connected in parallel to an AC feeder Lo through a branch line L1. The feeder Lo may be connected to a power system of an electric utility, or may be connected to a regional microgrid.

The charge-discharge station 50A may be installed in a public place such as a public parking lot, or alternatively, may be installed on a site of a company.

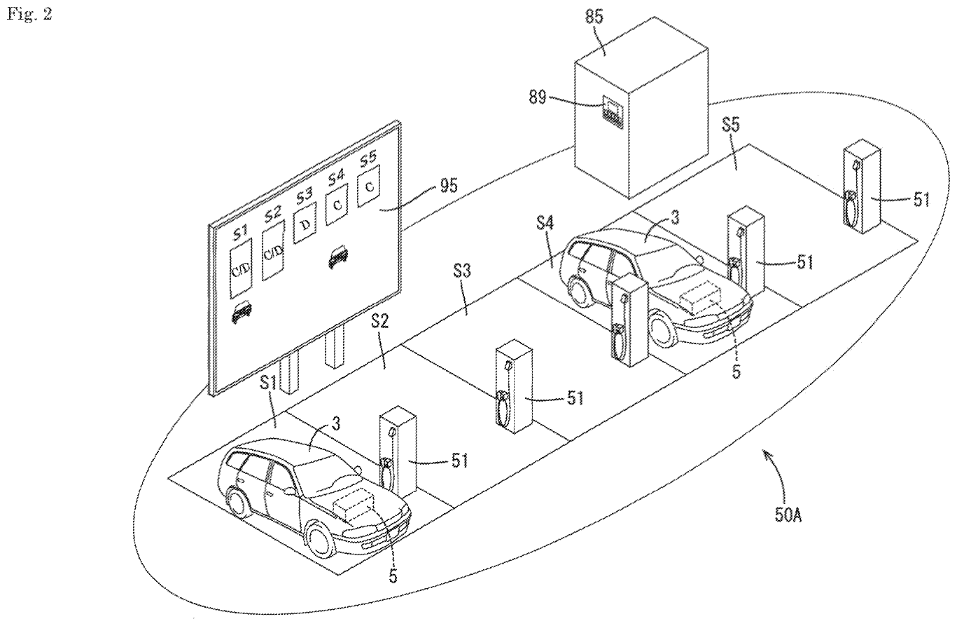

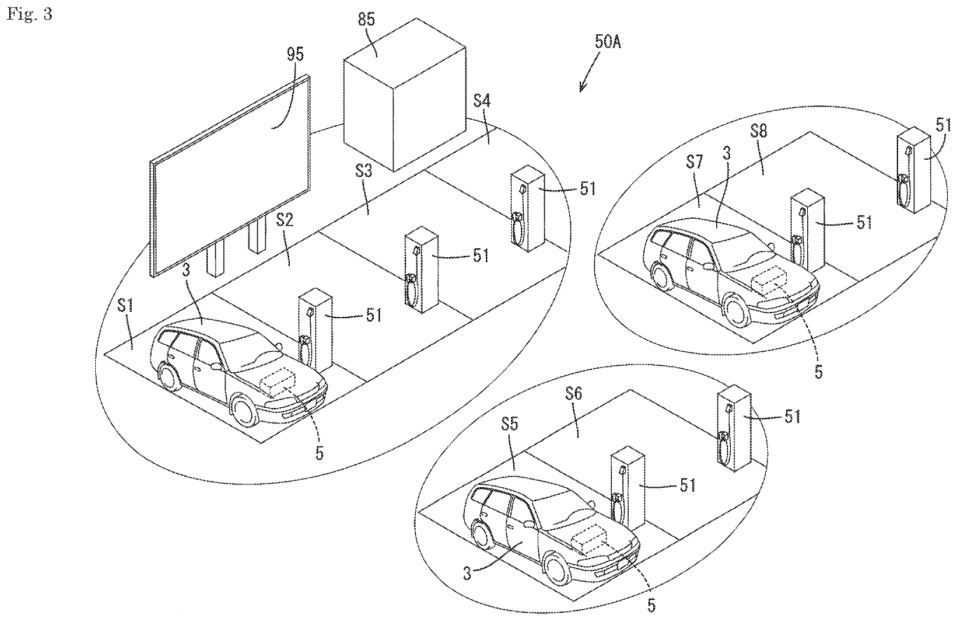

The charge-discharge station 50A may be a centralized type in which parking spaces S1 to S5 are arranged adjacent to each other as illustrated in FIG. 2, or may be a distributed type in which parking spaces S1 to S8 are disposed in a distributed manner as illustrated in FIG. 3.

In the distributed type illustrated in FIG. 3, a plurality of parking lots each having parking spaces S1 to S4, S5 to S6, and S7 to S8 for plural vehicles may be disposed apart from each other, or a parking space for a single vehicle may be disposed apart. The parking lots having the parking spaces S1 to S4, S5 to S6, and S7 to S8 for the plural vehicles may be disposed on different floors in a building.

In this embodiment, each parking space (S1, S2, . . . ) includes the charge-discharge stand 51, but the present invention is not limited to this form.

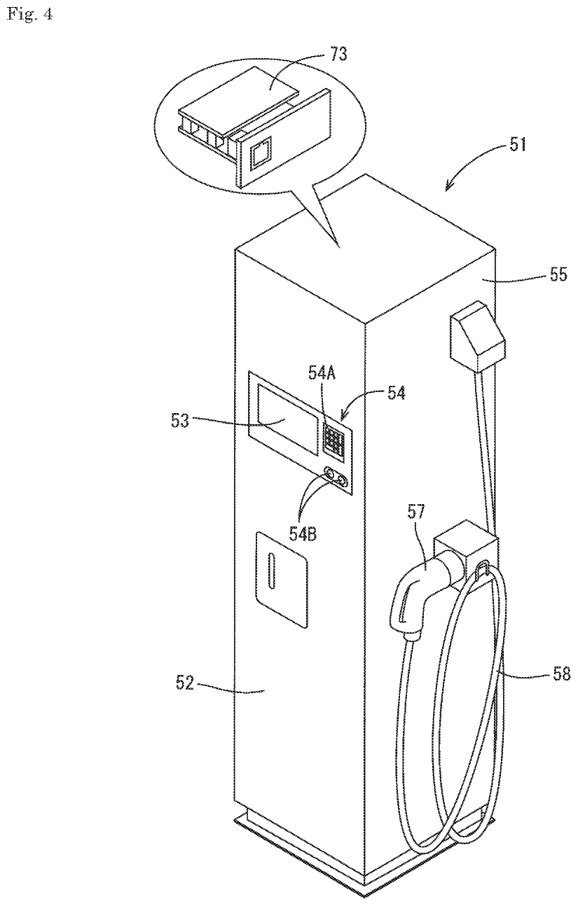

The charge-discharge stand 51 is, for example, a box shape elongated in a vertical direction as illustrated in FIG. 4, and includes a display panel 53 and an operation unit 54 on a front wall 52 of a housing. The operation unit 54 includes an input key 54A (or a touch panel) and an execution key 54B. A side wall 55 of the housing holds a charge-discharge connector 57 and a charge-discharge cable 58. The charge-discharge stand 51 includes a communication board 73 (for example, a network interface card) in the housing.

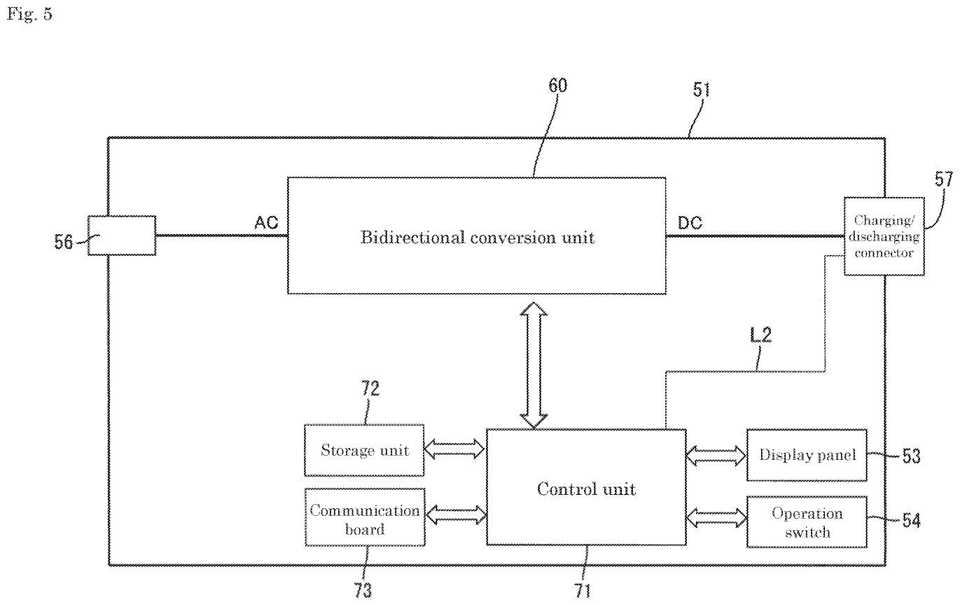

FIG. 5 is a block diagram illustrating an electrical configuration of the charge-discharge stand 51. The charge-discharge stand 51 includes a bidirectional conversion unit 60, a control unit 71, a storage unit 72, the communication board 73, the display panel 53, and the operation unit 54.

The communication board 73 is used for communication with the management device 85 and another charge-discharge stand 51. A communication specification may be wired communication or wireless communication, and the wireless communication is used in this embodiment.

One end of the bidirectional conversion unit 60 is connected to an AC terminal 56, and the other end is connected to the charge-discharge connector 57. The AC terminal 56 is connected to the branch line L1 in FIG. 1.

The bidirectional conversion unit 60 is a bidirectional conversion circuit that selectively performs forward conversion (converter function) converting AC power AC into DC power DC and reverse conversion (inverter function) converting DC power DC into AC power AC.

The control unit 71 controls the bidirectional conversion unit 60 by giving a command to the bidirectional conversion unit 60.

The charge-discharge connector 57 is inserted into a connection portion (inlet) of the vehicle such as an automobile 3 in FIG. 3, and the charge-discharge connector 57 is fitted to the charge-discharge connector of the automobile 3.

The bidirectional conversion unit 60 of the charge-discharge stand 51 and an in-vehicle battery 5 of the automobile 3 are electrically connected by fitting the connector, and the in-vehicle battery 5 can be charged or discharged using the bidirectional conversion unit 60.

Specifically, the charge-discharge stand 51 charges the in-vehicle battery 5 by causing the bidirectional conversion unit 60 to perform a forward conversion operation, and discharges the in-vehicle battery 5 by causing the bidirectional conversion unit 60 to perform a reverse conversion operation.

In addition, due to the fitting of the connector, the control unit 71 is communicably connected to the automobile 3 through a signal line L2, and receives information about SOC (state of charge) of the in-vehicle battery 5.

The control unit 71 calculates a charge amount and a discharge amount of the in-vehicle battery 5 based on output of the bidirectional conversion unit 60. The control unit 71 monitors fluctuation of the SOC of the in-vehicle battery 5 due to the charging or the discharging.

The management device 85 in FIG. 1 includes a control unit 86, a storage unit 87, and a communication device 88. The communication device 88 is used for communication with the communication board 73 of each charge-discharge stand 51.

In this embodiment, the management device 85 is a “master unit”, and each charge-discharge stand 51 is a “slave unit”. The management device 85 acquires information about the use condition and setting of a mode described later by communication from each charge-discharge stand 51, and manages the information in a unitary manner. Instead of using the management device 85, one of the charge-discharge stands 51 may be a “master unit”.

### 2. Mode and Batch Display of Charge-Discharge Stand 51

In the charge-discharge stand 51 of this embodiment, three types of modes (1) to (3) can be set as the mode regarding the charge-discharge. The mode regarding the charge-discharge of the charge-discharge stand 51 is not limited thereto.
(1) Charging mode
(2) Discharging mode
(3) Charging/discharging mode

The “charging mode” is a mode charging the in-vehicle battery 5 of the automobile 3 connected to the charge-discharge stand 51.

The “discharging mode” is a mode discharging the in-vehicle battery 5 of the automobile 3 connected to the charge-discharge stand 51. For example, the “discharging mode” is set in the charge-discharge stand 51 for an emergency power supply use during a disaster.

The “charging/discharging mode” is a mode charging or discharging the battery 5 of the automobile 3 connected to the charge-discharge stand 51. For example, the “charging/discharging mode” is set in the charge-discharge stand 51 for an energy management purpose.

The mode regarding the charge-discharge of each charge-discharge stand 51 can be set and changed by the management device 85. Not limited to the management device 85, the mode may be set and changed at each charge-discharge stand 51.

The storage unit 87 of the management device 85 stores information about mode regarding the charge-discharge of each charge-discharge stand 51. That is, which mode among the modes (1) to (3) each charge-discharge stand 51 is currently set is stored.

Based on the information stored in the storage unit 87, the management device 85 collectively displays the mode regarding the charge-discharge of the charge-discharge stand 51 on a predetermined display device. In this embodiment, the modes regarding the charge-discharge of the respective charge-discharge stands 51 are collectively displayed on the dedicated display panel 95 (see FIGS. 2 and 3) installed on the site of the charge-discharge station 50A.

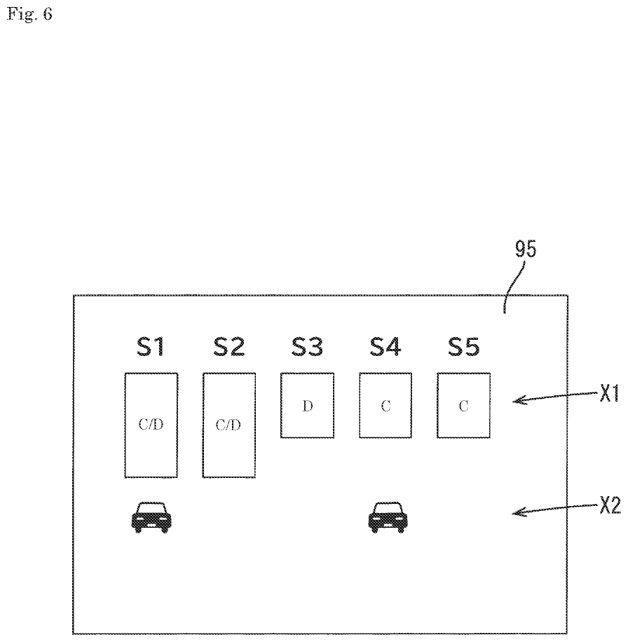

FIG. 6 illustrates an example of a display mode on the display panel 95, and two display items are vertically arranged and displayed below signs (or marks) “S1 to S5” indicating the respective parking spaces.

A display X1 on a first stage indicates the “mode regarding the charge-discharge” of each charge-discharge stand 51, and a display X2 on a second stage indicates the “connection condition of the automobile”.

In the first stage, the sign or mark indicating the mode regarding the charge-discharge of each charge-discharge stand 51 is displayed. The sign of “C/D” in FIG. 6 indicates the “charging/discharging mode”. The sign of “C” indicates the “charging mode”, and the sign of “D” indicates the “discharging mode”.

In the example of FIG. 6, two charge-discharge stands 51 of “S1”, “S2” are currently set to the “charging/discharging mode”. The charge-discharge stand 51 of “S3” is currently set to the “discharging mode”, and two charge-discharge stands 51 of “S4”, “S5” are currently set to the “charging mode”.

In the second stage, the sign or mark indicating the connection condition of the automobile 3 to each charge-discharge stand 51 is displayed. The mark of the automobile in FIG. 6 indicates that the automobile 3 is connected to the charge-discharge stand 51. A blank (no mark) indicates that the automobile 3 is not connected to the charge-discharge stand 51.

In the example of FIG. 6, two charge-discharge stands 51 of “S1”, “S4” are in automobile connection (in use). Three charge-discharge stands 51 of “S2”, “S3”, “S5” are not used.

### 3. Description of Effect

In this configuration, the modes regarding the charge-discharge of the respective charge-discharge stands 51 are collectively displayed on the display panel 95, so that the user and the manager of the charge-discharge station 50A can easily grasp the modes regarding the charge-discharge of the respective charge-discharge stands 51 by checking the display panel 95.

Consequently, as compared with the case where the mode is individually displayed for each charge-discharge stand 51, the time and labor required for mode check can be reduced, and the convenience of the charge-discharge station 50A can be improved.

For example, the user who visits the station 50A to charge the automobile 3 can quickly find the charge-discharge stand 51 to which the user's own automobile 3 should be connected by checking the display panel 95.

In particular, as illustrated in FIG. 3, when the charge-discharge stand 51 is installed in each of the parking spaces located in a dispersed manner, the user or the manager is not required to move between the charge-discharge stands for the mode check, and the time and labor required for the mode check can be largely reduced.

### Second Embodiment

In a second embodiment, instead of the management device 85 of the first embodiment, one of the plurality of charge-discharge stands 51 is caused to function as the master unit.

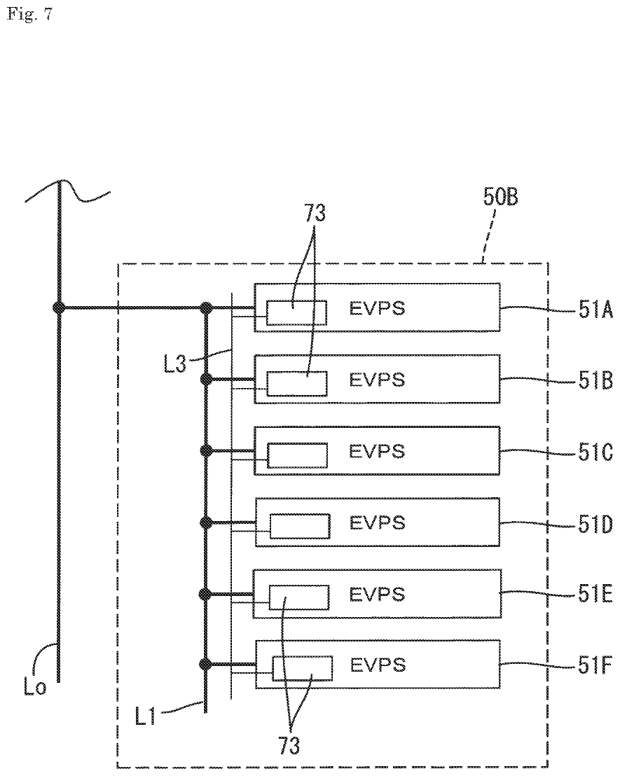

FIG. 7 is a system configuration diagram illustrating a charge-discharge station 50B that does not include the dedicated management device 85. The charge-discharge station 50B includes a plurality of charge-discharge stands 51A to 51F, and does not include the management device 85 and the display panel 95 that are described in the first embodiment.

The six charge-discharge stands 51A to 51F are communicably connected through a communication line L3, and the charge-discharge stand 51A that is the “master unit” and other charge-discharge stands 51B to 51F that are the “slave units” communicate with each other. The communication between the charge-discharge stand 51A and the other charge-discharge stands 51B to 51F may be serial communication. The communication between stands is not limited to wired communication, but may be wireless communication.

The charge-discharge stand 51A may be installed at a predetermined position of the station 50B, or may have a sign such as a lamp, or the display panel 53 (see FIG. 4) thereof may display the “master unit” such that the user or the manager can easily identify the charge-discharge stand 51A that is the “master unit”.

The charge-discharge stand 51A acquires information about the mode regarding the charge-discharge from each of the charge-discharge stands 51B to 51F by the communication, and stores the information in the storage unit 72 (see FIG. 5) in the unitary manner.

The charge-discharge stand 51A that is the “master unit” collectively displays the mode regarding the charge-discharge of each charge-discharge stand 51 on the display panel 53 (see FIG. 4) of the charge-discharge stand 51A based on information stored in the storage unit 72. For example, the display panel 53 may adopt the display illustrated in FIG. 6.

In this configuration, the mode regarding the charge-discharge of each charge-discharge stand 51 is collectively displayed on the display panel 53 of the charge-discharge stand 51A, so that the cost and space installing the dedicated management device 85 and the display panel 95 are not required.

### Third Embodiment

In a third embodiment, the plurality of charge-discharge devices are grouped according to the mode, and the display device displays the mode of the charge-discharge stand for each group. More specifically, the plurality of charge-discharge stands having the common mode are grouped into one block B, and the mode is displayed for each block.

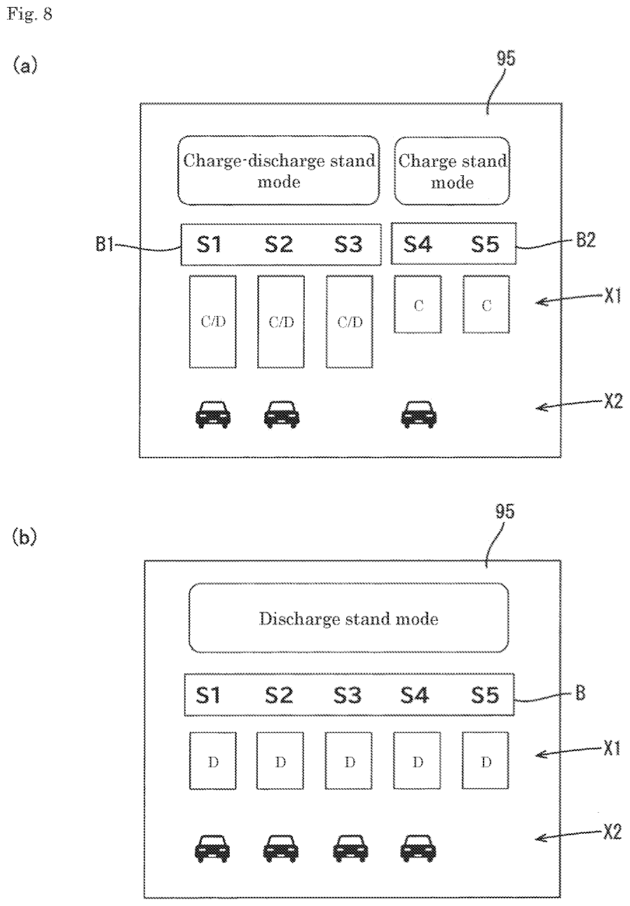

FIG. 8 illustrates an example of the display mode, and a “block mode” is displayed in the upper part of the signs “S1 to S5” indicating the parking spaces. In addition, “mode for each charge-discharge stand” is displayed on the first stage of a lower stage of the signs “S1 to S5”, and the “connection condition of the automobile” is displayed on the second stand.

Portions different from the display example of the first embodiment (the display mode in FIG. 6) will be described below.

In the example of FIG. 8(a), among the five charge-discharge stands 51, the modes of the three charge-discharge stands 51 arranged in S1 to S3 are common in the “charging/discharging mode”, and the modes of the two charge-discharge stands arranged in S4, S5 are common in the “charging mode”.

The management device 85 displays a “charge-discharge stand mode” in the upper stage of a first block B1 including three charge-discharge stands S1 to S3, and displays a “charge stand mode” in the upper stage of a second block B2 including two charge-discharge stands S4, S5.

In the example of FIG. 8(b), the “discharge mode” is common to all the modes of the five charge-discharge stands 51 arranged in S1 to S5. Accordingly, the five charge-discharge stands 51 form one block B, and the “discharge stand mode” is displayed above the block B.

In this configuration, the mode can be easily checked as compared with the case where the mode is displayed on the display device for each charge-discharge stand. In addition, the manager of the charge-discharge station can smoothly change the mode of the plurality of charge-discharge stands with no error, and can easily perform energy management. This is particularly effective when the station includes a large number of charge-discharge stands.

### Fourth Embodiment

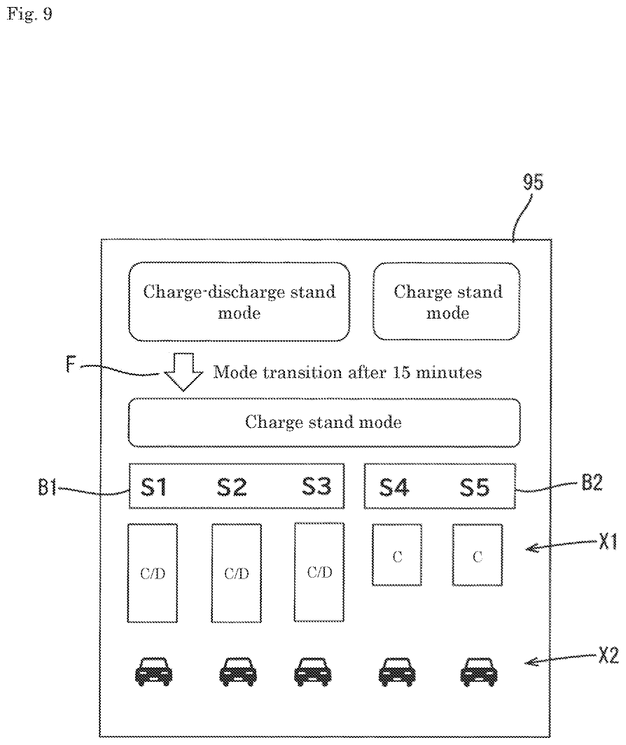

In a fourth embodiment, the management device 85 displays mode transition information on the display panel 95. For example, as illustrated in FIG. 9, when the mode is to be switched after a predetermined time, the current mode and the mode after the transition are vertically displayed, and an arrow F indicating the transition of the mode is displayed between the current mode and the mode after the transition. A scheduled transition time may be displayed in the vicinity of the arrow.

In the display example of FIG. 9, it is displayed that the first block B1 is switched from the “charge-discharge stand mode” to the “charge stand mode” after a predetermined time (15 minutes) from a current point of time.

In this configuration, the mode transition information is displayed to notify the user of the switching of the mode of the charge-discharge stand 51, so that the efficient use of the charge-discharge station can be promoted.

### Fifth Embodiment

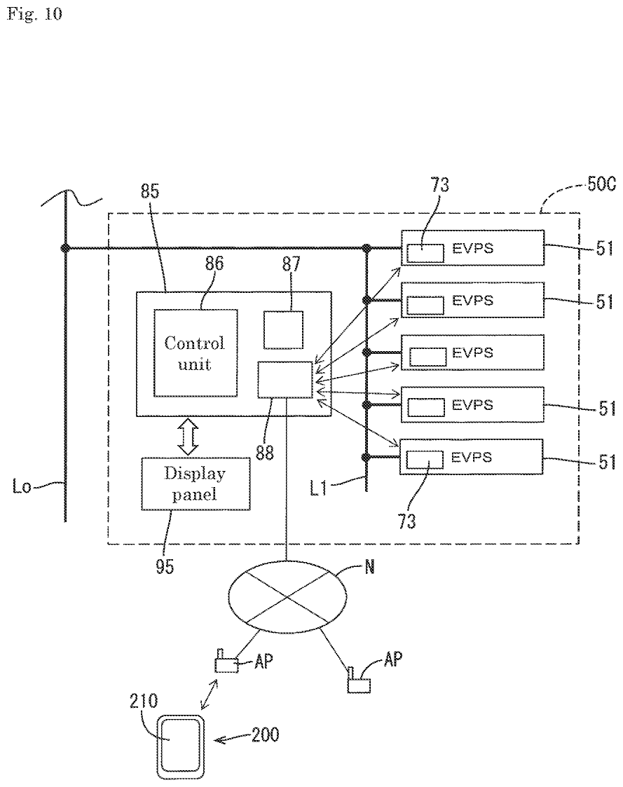

FIG. 10 is a block diagram illustrating a charge-discharge station 50C. Similarly to the charge-discharge station 50A of the first embodiment, the charge-discharge station 50C includes a plurality of charge-discharge stands 51, the management device 85, and the display panel 95. Alternatively, the charge-discharge station 50C may not include the dedicated management device 85 and the display panel 95 like the second embodiment.

The management device 85 includes the control unit 86, the storage unit 87, and the communication device 88. The storage unit 87 stores the information about the mode regarding the charge-discharge of each charge-discharge stand 51 and a web server program.

The management device 85 is connected to a network N through the communication device 88. The control unit 86 executes the web server program to provide an information terminal device 200 connected through the network N with display information collectively displaying the mode regarding the charge-discharge of each charge-discharge stand 51. The management device 85 functions as a web server.

The information terminal device 200 is, for example, a smartphone or a tablet, and is connected to the network N through an access point AP.

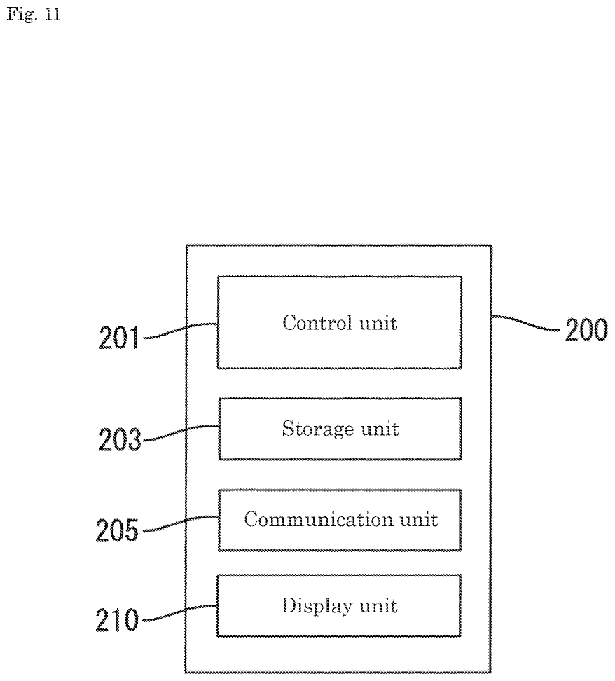

As illustrated in FIG. 11, the information terminal device 200 includes a control unit 201, a storage unit 203, a communication unit 205, and a display unit 210.

The storage unit 203 stores a web browser program. When executing the web browser program, the control unit 201 accesses the management device 85 through the network N to request the transmission of the display information, and displays the display information transmitted from the management device 85 on the display unit 210. The information terminal device 200 functions as a web browser.

The information terminal device 200 collectively displays the display information provided by the web server function of the management device 185 on the display unit 210 as the mode regarding the charge-discharge of the charge-discharge stands 51 through the web browser. In addition to the information about the mode, information about the connection condition of the automobile may be collectively displayed.

In this configuration, even when the user or the manager is not in the charge-discharge station 50C, the user or the manager can check the mode regarding the charge-discharge of each charge-discharge station 51 with the information terminal device 200, and the efficient use of the charge-discharge station 50C can be promoted.

<Modifications>

The present invention is not limited to the above described embodiment. For example, the following modifications are also included in the technical scope of the present invention.
(1) In the first embodiment, the automobile 3 is charged or discharged using the charge-discharge stand 51. The charge-discharge stand 51 can be appropriately used for the vehicle other than the automobile 3 as long as the vehicle mounting the in-vehicle battery 5. For example, an electric motorcycle may be charged or discharged using the charge-discharge stand 51.
(2) In the first embodiment, the modes regarding the charge-discharge of the respective charge-discharge stands 51 are collectively displayed on the display panel 95 provided in the charge-discharge station 50A. Alternatively, the information may be collectively displayed on an external display device separated from the charge-discharge station 50A. For example, the management device 85 may transmit the information about the charging/discharging mode of each charge-discharge stand 51 to a host system, and display the information on the display unit or the display panel of the host system.
(3) In the fifth embodiment, a portable information terminal device such as a smartphone or a tablet has been described as an example of the information terminal device. The information terminal device may be a stationary computer or the like.
(4) In the fifth embodiment, the management device 85 is the master unit and the web server. Instead, one of the charge-discharge stands 51 may be used as the master unit and the web server. That is, the control unit 71 of one charge-discharge stand 51 may function similarly to the control unit 86 of the management device 85.

### Sixth Embodiment

The charge-discharge station according to this embodiment includes the plurality of charge-discharge devices and the display device that collectively displays the use condition and the use schedule of the plurality of charge-discharge devices.

The charge-discharge station has the configuration in FIGS. 1 to 5, and the display mode on the display panel 95 is different from that in FIG. 2.

Similarly to FIG. 2, the storage unit 87 (see FIG. 1) of the management device 85 stores the information about the mode regarding the charge-discharge of each charge-discharge stand 51. In addition to the management of the mode regarding the charge-discharge of each charge-discharge stand 51, the management device 85 collects and manages the information about the connection condition of the automobile 3 to each charge-discharge stand 51, the use condition of each charge-discharge stand 51, and the use schedule from each charge-discharge stand 51. These pieces of information are stored in the storage unit 87.

Based on the data stored in the storage unit 87, the management device 85 collectively displays the following display items for each charge-discharge stand 51 on a predetermined display device. In this embodiment, the following display items are collectively displayed on the dedicated display panel 95 (see FIGS. 2 and 3) installed in the site of the charge-discharge station 50A.

<Display Item>
(A) Mode regarding charge-discharge (default)
(B) Connection condition of automobile
(C) Setting information by current user
(D) Current use condition
(E) Use schedule

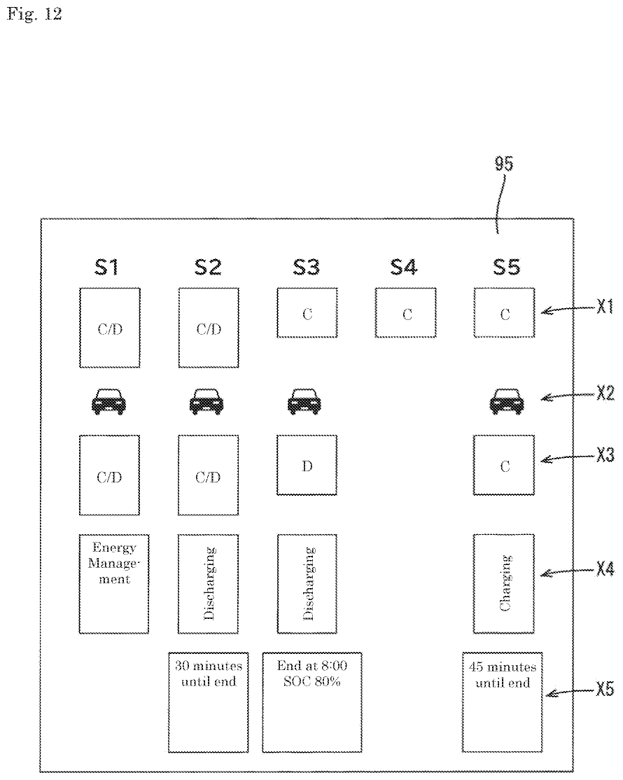

FIG. 12 illustrates an example of the display mode on the display panel 95, and five display items are vertically arranged and displayed below the signs (or marks) “S1 to S5” indicating the respective parking spaces.

A display X1 on a first stage indicates the “mode regarding the charge-discharge” of each charge-discharge stand 51, and a display X2 on a second stage indicates the “connection condition of the automobile”.

A display X3 of a third stage indicates the “setting information by the current user”. “The current user” is a user who actually uses the charge-discharge stand 51 at present. A display X4 of a fourth stage indicates the “current use condition”, and a display X5 of the fifth stage indicates the “use schedule”.

In the first stage, the mode (default) regarding the charge-discharge of each charge-discharge stand 51 is displayed. The default means an item set by the manager of the charge-discharge station 50A.

The sign of “C/D” in FIG. 12 indicates the “charging/discharging mode”. The sign of “C” indicates the “charging mode”, and the sign of “D” indicates the “discharging mode”.

In the example of FIG. 12, two charge-discharge stands 51 of “S1”, “S2” are currently set to the “charging/discharging mode”. Three charge-discharge stands 51 of “S3” to “S5” are currently set in the “charging mode”.

In the second stage, the sign or mark indicating the connection condition of the automobile 3 with respect to each charge-discharge stand 51 or a service mode described later is displayed. The mark of the automobile in FIG. 6 indicates that the automobile 3 is connected to the charge-discharge stand 51. A blank (no mark) indicates that the automobile 3 is not connected to the charge-discharge stand 51.

The state in which the automobile 3 is connected to the charge-discharge stand 51 means the state in which the charge-discharge connector 57 is inserted into the inlet on the automobile side, and is not necessarily limited to the state in which a charge or discharge operation is performed.

In the example of FIG. 12, four charge-discharge stands 51 of “S1”, “S2”, “S3”, “S5” are in automobile connection (in use). The charge-discharge stand 51 of “S4” is not used.

In the second stage, an occupancy condition of the parking space S by the automobile 3 may be displayed instead of the connection condition of the automobile 3. A sensor sensing the automobile 3 may be provided in the parking space S, and the state in which the automobile 3 occupies the parking space S (regardless of the connection of the charge/discharge connector) may be detected to display the occupancy condition by the automobile 3.

In the third stage, the information set for the charge-discharge stand 51 by the current user before the start of use of the charge-discharge stand 51 is displayed. For example, when the mode regarding the charge-discharge is changed from the default, the changed mode is displayed. The default mode is displayed for the stand in which the setting is not changed.

In the example of FIG. 12, in the charge-discharge stand 51 of “S3”, the display on the first stage is “C”, whereas the display on the third stage is “D”. This means that the charge-discharge stand 51 of “S3” is changed from “the charging mode” to “the discharging mode” before the current user starts using the charge-discharge stand.

The fourth stage displays the current use condition of each charge-discharge stand 51. That is, the information indicating whether each charge-discharge stand 51 is currently in use is displayed.

The sign “Energy Management” indicates that the charge-discharge stand 51 is being used for “energy management stand”. The sign of “discharging” indicates that “currently discharging”, and the sign of “charging” indicates that “currently charging”.

In the example of FIG. 12, four charge-discharge stands 51 of “S1”, “S2”, “S3”, “S5” are in use, and the charge-discharge stand 51 of “S4” is not in use.

The fifth stage displays the use schedule of each charge-discharge stand 51, namely, a “scheduled use end time” and a “remaining time until use end”. In the fifth stage, the information about the SOC at the end of use of the in-vehicle battery 5 and the scheduled time at which the connection between the charge-discharge stand 51 and the automobile 3 is released may be displayed together.

The “scheduled use end time” and the “remaining time until use end” can be obtained from the use time of the charge-discharge stand 51.

The use time of each charge-discharge stand 51 can be set on each charge-discharge stand 51 by the user using the input key 54A or the execution key 54B of the operation unit 54 before the start of use. When the user sets (inputs) only the target SOC, the use time can be predicted (calculated) in each charge-discharge stand 51 based on the following information.
(a) SOC before start of charge (before start of discharge)
(b) Target SOC at end of charge (at end of discharge)
(c) Charge amount per unit time (discharge amount)

In the example of FIG. 12, “remaining 30 minutes” is displayed until the end of use of the charge-discharge stand 51 of “S2”. The charge-discharge stand 51 of “S3” displays that “the use end time is 8:00, and the discharge may be performed up to SOC 80%”. It is displayed that “remaining 45 minutes” elapses until the end of use of the charge-discharge stand 51 of “S5”.

In this configuration, the five display items of the plurality of charge-discharge stands 51 are collectively displayed on the display panel 95, so that the user or the manager of the charge-discharge station 50A can easily grasp the use condition and the use schedule by checking the display panel 95.

Specifically, when the use conditions (the display X4 on the fourth stage) are collectively displayed for the plurality of charge-discharge stands 51, the user or the manager can easily determine which charge-discharge stand 51 is currently available.

When the charge/discharge schedules are collectively displayed for the plurality of charge-discharge stands 51, the user or the manager can easily check how long the use state of each charge-discharge stand 51 continues and from when each charge-discharge stand is available.

Consequently, the next user who wants to use the charge-discharge stand 51 can take an action such as visiting the charge-discharge station 50A in accordance with the scheduled end of use of the charge-discharge stand 51 by the current user. For example, when the manager of the charge-discharge station 50A operates the charge-discharge stand 51 for “energy management” or for “emergency power supply”, the manager can arrange the automobile 3 to be charged and discharged next in accordance with the end of use.

### Seventh Embodiment

In a seventh embodiment, similarly to the second embodiment in FIG. 7, one of the plurality of charge-discharge stands 51 is caused to function as the master unit instead of the management device 85. The charge-discharge stand 51A in FIG. 7 acquires the information about the above-described five display items from each of the charging and discharging stands 51B to 51F by the communication, and stores the information in the storage unit 72 (see FIG. 5) in the unitary manner.

Based on the information stored in the storage unit 72, the charge-discharge stand 51A that is the “master unit” collectively displays five display items for each charge-discharge stand 51 on the display panel 53 (see FIG. 4) of the charge-discharge stand 51A. For example, the display panel 53 may adopt the display illustrated in FIG. 12.

In this configuration, five display items are collectively displayed on the display panel 53 of the charge-discharge stand 51A, so that the cost and space installing the dedicated management device 85 or the display panel 95 are not required.

### Eighth Embodiment

A charge-discharge station according to this embodiment includes the plurality of charge-discharge devices and the control unit, and the control unit transmits the display information collectively displaying the use condition and the use schedule of the plurality of charge-discharge devices to the information terminal device in response to the request from the information terminal device connected through the network. The charge-discharge station has the configuration in FIG. 10.

In this configuration, even when the user or the manager is not in the charge-discharge station 50C, the user or the manager can check the five display items of each charge-discharge station 51 with the information terminal device 200, and the efficient use of the charge-discharge station 50C can be promoted.

### Ninth Embodiment

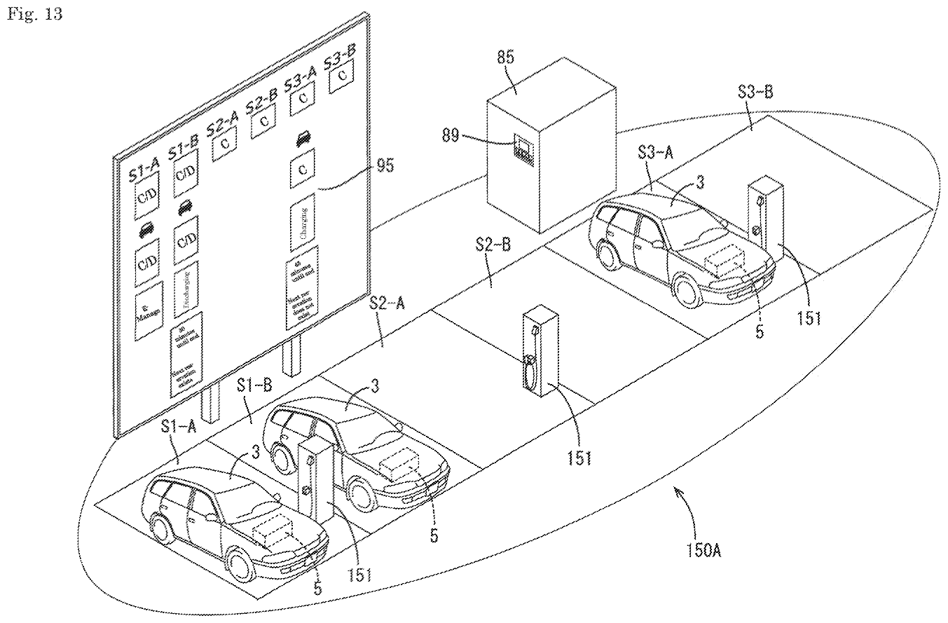

FIG. 13 is a perspective view illustrating a charge-discharge station 150A according to a ninth embodiment. The charge-discharge station 150A includes three charge-discharge stands 151. Parking spaces S1-A, S2-A, S3-A, and S1-B, S2-B, S3-B are installed on both sides of each charge-discharge stand 151.

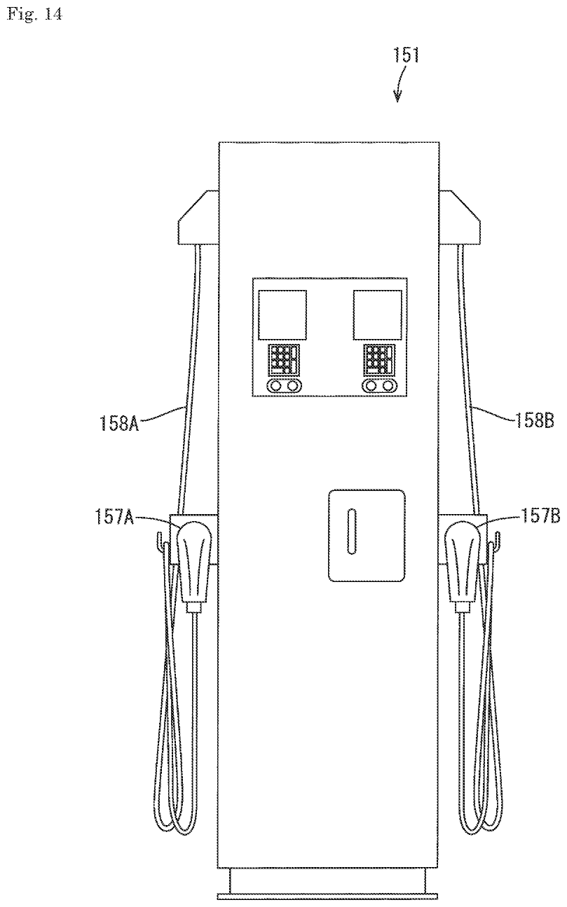

FIG. 14 is a front view illustrating the charge-discharge stand 151. The charge-discharge stand 151 includes two charge-discharge connectors 157A, 157B and two charge-discharge cables 158A, 158B. The charge-discharge stand 151 is the multi-connection type charge-discharge device capable of simultaneously connecting two automobiles 3.

Two automobiles 3 can be connected to the charge-discharge stand 151, so that the number of charge-discharge stands 151 installed in the charge station 150A can be reduced. This can reduce the cost required for the installation, maintenance, and management of the charge-discharge stand 151.

The charge-discharge station 150A may include the charge-discharge stand 51 disclosed in the first embodiment and the multi-connection type charge-discharge stand 151.

In addition to the management of the mode regarding the charge-discharge of each charge-discharge stand 151, the management device 85 collects the pieces of information about the connection condition of the automobile 3 to each charge-discharge stand 151 and the use condition and the use schedule of each charge-discharge stand 151 from each charge-discharge stand 151, and displays the collected pieces of information on the display panel 95.

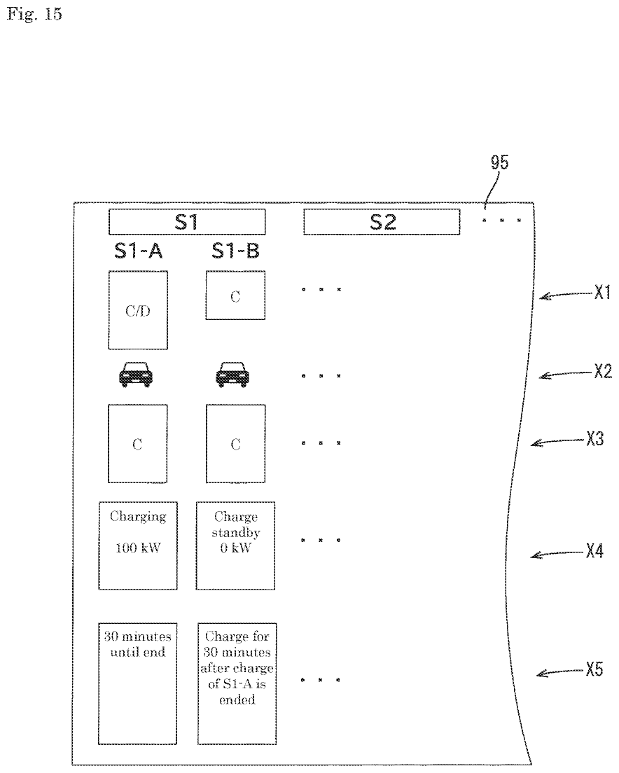

FIG. 15 illustrates a display example of the display panel 95. The first stage displays the “mode regarding the charge-discharge” of each of the charge-discharge stands 151, and the second stage displays the “connection condition of the automobile” (X1, X2). In the third stage, the “setting information by the current user” is displayed (X3). These are the same as those in the first embodiment.

In the fourth stage, the following two items are displayed as the use condition of the automobile 3 connected to the charge-discharge stand 151 (X4).
(d) Charge (discharge) status of each automobile
(e) Charge (discharge) power [kW]

The charge (discharge) status is “use start standby”, “charge (discharge) start”, “charge (discharge)”, “use end”, and the like. The charge output is charge power of the charge-discharge stand 151 for each automobile 3.

A priority charging (discharging) system is a system charging (discharging) the automobiles 3 according to the priority order when two automobiles 3 are connected to the charge-discharge stand 151. The priority order may be the order in which the automobile 3 is connected to the charge-discharge stand 151, or may be determined by another approach.

FIG. 15 illustrates the display example in the case where, in the two automobiles 3 connected to the charge-discharge stand 151, the automobile 3 parked in the parking space S1-A is preferentially charged and the automobile 3 parked in the parking space S1-B is waiting for the start of charge (waiting in line).

“Charging, 100 kW” is displayed as the use condition of the automobile 3 in the parking space S1-A that is preferentially charged, and “charge standby, 0 kW” is displayed as the use condition of the automobile 3 in the parking space S1-B that is waiting in line (X4).

On the fifth stage, the use schedule of the charge-discharge stand 151, namely, the “scheduled use end time” and the “remaining time until use end” are displayed (X5). This example illustrates the display example in which the use schedule of the automobile 3 in the parking space S1-A that is preferentially charged is “30 minutes until the end” and the use schedule of the automobile 3 in the parking space S1-B that is waiting in line is “charge for 30 minutes after S1-A is charged”.

When the charge (discharge) status is switched due to the progress of the charge (discharge), update information about the status is sent from the charge-discharge stand 151 to the management device 85. When the update information about the status is received, the management device 85 sends an instruction to the display panel 95 to update the charge status.

For example, when the charge of the automobile 3 in the parking space S1-A, which is preferentially charged, ends, the charge status of the automobile 3 in the parking space S1-A is switched from the display of “charging, 100 kW” to the display of “charge completed”. In addition, the charge status of the automobile 3 in the parking space S1-B waiting in line is switched from “charge standby, 0 kW” to “charging, 100 kW”.

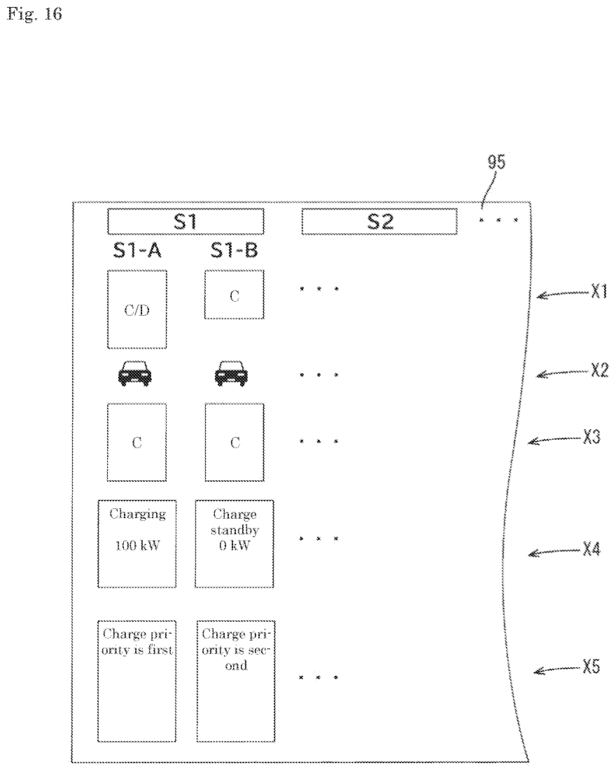

The display of the use schedule of the charge-discharge stand 151 may be changed to the display of the priority order of the charge (discharge) (display X5 in the fifth stage). FIG. 16 illustrate the display example in the case where the charge priority order of the automobile 3 parked in the parking space S1-A is first and the charge priority order of the automobile 3 parked in the parking space S1-B is second.

The parallel charge (discharge) system is a system for charging (discharging) two automobiles 3 in parallel when the two automobiles 3 are connected to the charging and discharging stand 151.

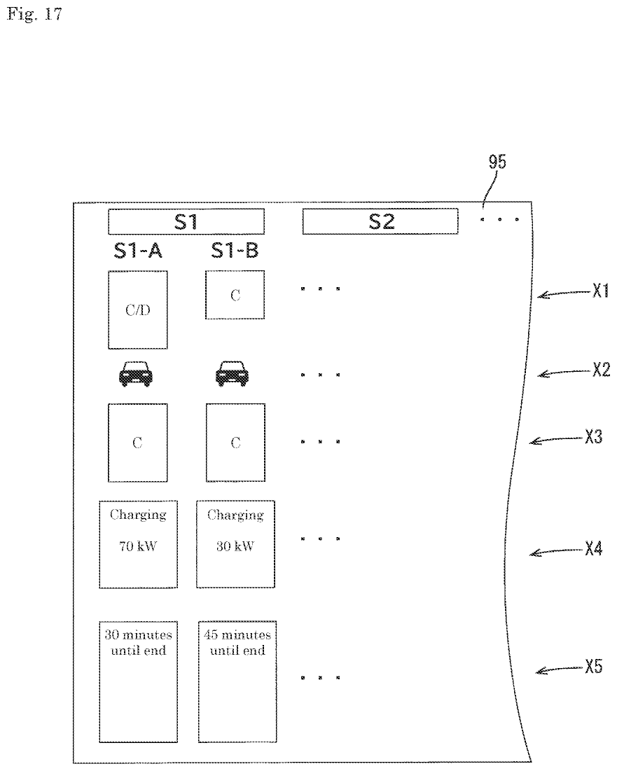

FIG. 17 illustrates the display example of the display panel 95 when two automobiles 3 are connected to the charge-discharge stand 151 and charged at 70 kW and 30 kW. “Charging, 70 kW” is displayed as the use condition of one automobile 3, and “charging, 30 kW” is displayed as the use condition of the other automobile 3 (X4).

“30 minutes until end” is displayed as the use schedule of one automobile 3 charged in parallel, and “45 minutes until end” is displayed as the use schedule of the other automobile 3 (X5).

When the charge (discharge) status of each automobile 3 is displayed on the display panel 95, the user can be notified of the use condition of the charge-discharge stand 151.

By displaying the charge (discharge) output from the charge-discharge stand 151 to each automobile 3 on the display panel 95, it is possible to notify the user of how much output the automobile 3 is charged or how much output the automobile 3 is discharged.

The user can know the charging/discharging start order of the automobile 3 by displaying the priority order of the charge (discharge) on the display panel 95.

### Tenth Embodiment

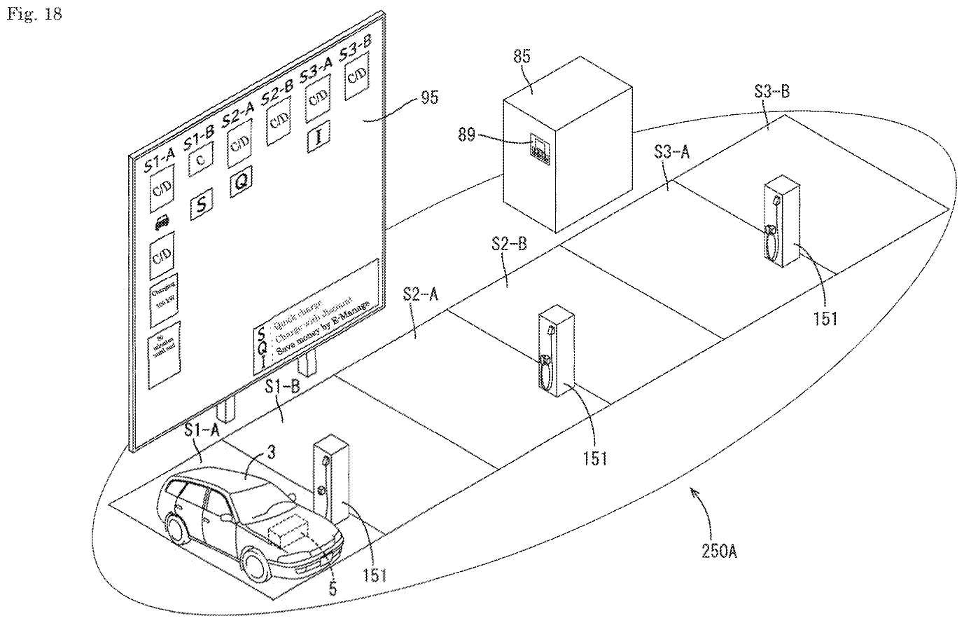

As illustrated in FIG. 18, a charge-discharge station 250A according to a tenth embodiment includes three charge-discharge stands 151. FIG. 18 illustrates the state in which the automobile 3 is connected only to the parking space S1-A.

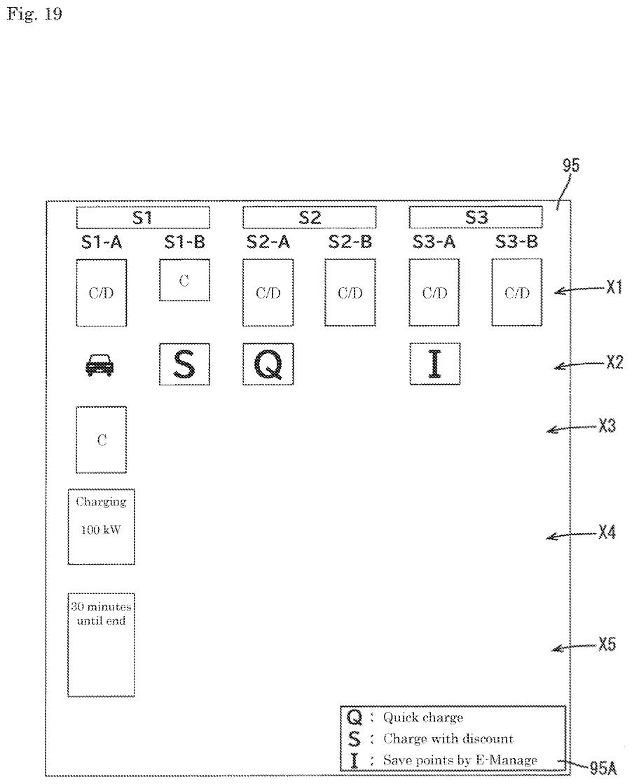

The management device 85 collects the information about the service mode that can be provided by each charge-discharge stand 151 from each charge-discharge stand 151, and displays the collected information on the display panel 95. FIG. 19 illustrates the display example of the service mode.

The service mode may be displayed on the display X2 of the second stage. Each of marks of “Q”, “S”, “I” is an example of a mark representing the service mode that can be provided. The meaning of the service mode represented by each mark is simply displayed on a description unit 95A in the display panel 95. When the automobile 3 is connected to the charge-discharge stand 151, the mark such as “Q” indicating the service mode is changed to an automobile mark indicating that the automobile is connected. Thereafter, “Q” may be displayed on the display X2 of the second stage of another parking space.

The parking space S2-A on which the mark “Q” is displayed indicates that the parking space S2-A is available in the first service mode Q. The parking spaces S1-B, S3-A in which the icons “S” and “I” are displayed indicate the parking spaces available in the second service mode S and the third service mode I.

The first service mode Q is the service mode having a high charge speed among the three types of service modes. “Q” is a first letter for “quick”.

When the first service mode Q is used, the automobile 3 can be rapidly charged with high output. The first service mode Q is the service mode useful for the user who wants to finish the charge in a short time.

The second service mode S is the service mode in which the charge speed is slower than that when the first service mode is used. “S” is a first letter of “slow”.

When the second service mode S is used, the automobile 3 can be normally charged at a lower output than the quick charge. When the second service mode S is used, the output of the charge-discharge station 150A is lower than that when the first service mode Q is used. For example, in the case where two automobiles 3 are connected to the charge-discharge station 150A and charged in parallel, one automobile 3 can be charged at a higher output by setting the charge of the other automobile 3 to the normal charge. In order to encourage the user to use the second service mode S, the power provider or the manager of the charging station 150A may give a discount of a charge fee, an electronic coupon, a point that can be exchanged for some benefit, or the like.

The second service mode S is the service mode useful for the user who thinks that the charge does not need to be finished in a short time.

The third service mode I is the service mode for the energy management purpose. For example, when the in-vehicle battery 5 mounted on the automobile 3 is charged and discharged according to a fluctuation in a supply and demand balance of the electric power in the electric power system, the demand can be adjusted to balance the supply and demand of the electric power.

“I” is the first letter for “incentive”. The “incentive” is money or other compensation given from the electric power provider or the like to the user who connects the automobile 3 to the charge-discharge stand 151 for the energy management purpose. The incentive includes a discount of a charge fee, an electronic coupon, a point that can be exchanged for some benefit, and the like. When the incentive is given to the user who connects the automobile 3 in the third service mode I, the user can be encouraged to connect more automobiles for the energy management purpose.

In the tenth embodiment, the user easily determines which charge-discharge stand 151 should be used by the display of the service mode, so that the convenience is high.

<Modifications>

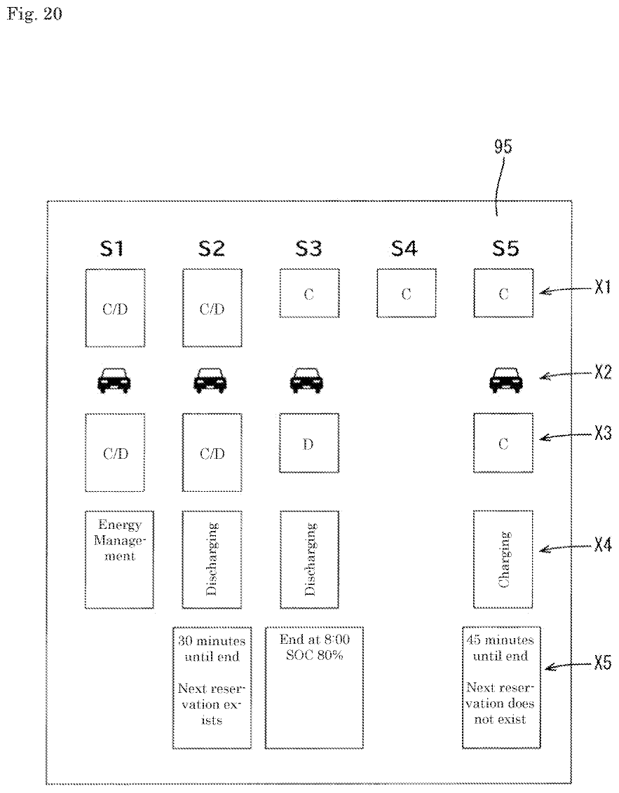

The present invention is not limited to the above described embodiment. For example, the following modifications are also included in the technical scope of the present invention.
(1) In the sixth embodiment, the automobile 3 is charged or discharged using the charge-discharge stand 51. The charge-discharge stand 51 can be appropriately used for the vehicle other than the automobile 3 as long as the vehicle mounting the battery 5. For example, an electric motorcycle may be charged or discharged using the charge-discharge stand 51.
(2) In the sixth embodiment, for each of the charge-discharge stands 51, five display items are collectively displayed on the display panel 95 of the charge-discharge station 50A. Alternatively, the information may be collectively displayed on an external display device separated from the charge-discharge station 50A. For example, the management device 85 may transmit the information about five display items of each charge-discharge stand 51 to the host system, and display the five display items on the display unit or the display panel of the host system.
(3) In the sixth embodiment, as illustrated in FIG. 12, five display items are displayed for each charge-discharge stand 51. Other items may be hidden as long as at least two items of “the current use condition (the display X4 on the fourth stage)” and “the use schedule (the display X5 on the fifth stage)” are included in the five display items.
(4) In the sixth embodiment, as the example of the display mode of “the current use condition (display X4 in the fourth stage)”, “Charging”, “Discharging”, “E-Manage”, and the like are displayed. The present invention is not limited thereto, and other display modes such as “in-use” and “non-use” may be used as long as the display enables the determination of the presence or absence of the use.
(5) In the sixth embodiment, the scheduled use end time of the charge-discharge stand 51 and the remaining time until the use end are displayed as the example of the use schedule (the display X5 on the fifth stage). That is, the current use schedule of the charge-discharge stand 51 is displayed. The display of the use schedule may be a future use schedule, and may display whether a reservation for next use of the charge-discharge stand 51 exists after the current use is ended. In addition, as illustrated in FIG. 20, both the current use schedule and the future use schedule may be displayed in the display X5 on the fifth stage.
(6) In the sixth embodiment, the setting information about the mode regarding the charge-discharge is displayed as the setting information (the display item in the third stage) by the current user. In addition to this, the setting information about the SOC at the end of use or the like may be displayed.
(7) In the eighth embodiment, the portable information terminal device such as the smartphone or the tablet is described as the example of the information terminal device. The information terminal device may be a stationary computer or the like.
(8) In the eighth embodiment, the management device 85 is the master unit and the web server. However, one of the charge-discharge stands 51 may be used as the master unit and the web server.
(9) In the tenth embodiment, the case where the charge-discharge station 250A includes three charge-discharge stands 151 is exemplified. The charge-discharge station 250A may include the charge-discharge stand 51, or all the charge-discharge stands may be the charge-discharge stand 51.
(10) In the tenth embodiment, three types of service modes are exemplified. Three or more service modes may exist. For example, a service mode in which the charge is performed at an output between an output of the rapid charge and an output of the normal charge may exist.

### DESCRIPTION OF REFERENCE SIGNS

50A, 50B, 50C: charge-discharge station
51: charge-discharge stand (charge-discharge device)
53: display panel (display device)
85: management device
95: display panel (display device)
200: information terminal device

1. A charge-discharge station for a vehicle, the charge-discharge station comprising:
a plurality of charge-discharge devices; and
a display device that collectively displays modes regarding charge-discharge of the plurality of charge-discharge devices.

2. The charge-discharge station according to claim 1, wherein the display device groups and displays the plurality of charge-discharge devices according to the mode, and displays the mode for each group.

3. The charge-discharge station according to claim 1, wherein when the mode is to be switched, the display device displays transition information about the mode.

4. The charge-discharge station according to claim 1, wherein the display device collectively displays the modes regarding the charge-discharge of the charge-discharge devices respectively installed in parking spaces located in a dispersed manner.

5. A charge-discharge station for a vehicle, the charge-discharge station comprising:
a plurality of charge-discharge devices; and
a control unit,
wherein the control unit transmits display information collectively displaying modes regarding charge-discharge of the plurality of charge-discharging devices to an information terminal device connected through a network in response to a request from the information terminal device.

6. A charge-discharge station comprising:
a plurality of charge-discharge devices; and
a display device that collectively displays a use condition and a use schedule of the plurality of charge-discharge devices.

7. The charge-discharge station according to claim 6, wherein the display device displays a scheduled use end time or a remaining time until the use end of each charge-discharge device as the use schedule.

8. The charge-discharge station according to claim 7, wherein the display device displays the scheduled use end time or the remaining time until the use end, the scheduled use end time being predicted based on setting of a charge state of an in-vehicle battery at a use end time point of the charge-discharge device.

9. The charge-discharge station according to claim 6, wherein the display device displays the charge state of the in-vehicle battery at the use end time point of the charge-discharge device.

10. The charge-discharge station according to claim 6, wherein the display device displays presence or absence of a next use reservation of each charge-discharge device as the use schedule.

11. The charge-discharge station according to claim 6, wherein the display device displays a service mode of each charge-discharge device.

12. The charge-discharge station according to claim 6, wherein at least one charge-discharge device of the plurality of charge-discharge devices is a multi-connection type charge-discharge device to which a plurality of vehicles can be connected.

13. The charge-discharge station according to claim 12, wherein the display device displays a charge status or a discharge status of each vehicle connected to the multi-connection type charge-discharge device as the use condition.

14. The charge-discharge station according to claim 12, wherein the display device displays a charge output from the charge-discharge device of a multi-connection type to each vehicle or a discharge output from each vehicle to the charge-discharge device as the use condition.

15. The charge-discharge station according to claim 12, wherein the display device displays priority order of which vehicle is preferentially charged for a plurality of vehicles connected to the multi-connection type charge-discharge device or which vehicle is preferentially discharged for the plurality of vehicles as the use schedule.

16. A charge-discharge station comprising:
a plurality of charge-discharge devices; and
a control unit,
wherein the control unit transmits display information collectively displaying a use condition and a use schedule of the plurality of charge-discharge devices to an information terminal device connected through a network in response to a request from the information terminal device.
